(19) United States
(12) Patent Application Publication
(10) Pub. No.: US 2024/0375092 A1
(43) Pub. Date: Nov. 14, 2024

(54) ELECTRICALLY HEATED CATALYST DEVICE

(71) Applicant: TOYOTA JIDOSHA KABUSHIKI KAISHA, Toyota-shi (JP)

(72) Inventors: Akemi SATOU, Toyota-shi (JP); Takeshi HIRABAYASHI, Toyota-shi (JP)

(21) Appl. No.: 18/616,693

(22) Filed: Mar. 26, 2024

(30) Foreign Application Priority Data
May 10, 2023 (JP) 2023-077700

(51) Int. Cl. B01J 35/00; B01D 53/94; B01J 23/44; B01J 23/46; B01J 27/224; B01J 35/56; F01N 3/20; F01N 3/28

(52) U.S. Cl. CPC B01J 35/19; B01D 53/9468; B01D 53/9472; B01J 23/44; B01J 23/464; B01J 27/224; B01J 35/56; F01N 3/2013; F01N 3/2803; B01D 2255/1023; B01D 2255/1025; B01D 2255/9022; B01D 2255/9032; B01D 2258/01; F01N 2370/02

(57) ABSTRACT

Provided is an electrically heated catalyst device that enables improving an exhaust gas purification performance. The electrically heated catalyst device of the present disclosure includes a substrate, an inflow side catalyst layer, and an outflow side catalyst layer. The substrate contains SiC. The inflow side catalyst layer contains Pd as a catalyst component. The outflow side catalyst layer contains Rh as a catalyst component. The substrate includes a partition wall defining a plurality of cells extending from an inflow side end surface to an outflow side end surface. The inflow side catalyst layer is disposed on a surface of the partition wall in an inflow side catalyst region. The inflow side catalyst region extends from an inflow side end of the partition wall along an extending direction to an outflow side by a distance of 60% to 90% of a total length in the extending direction of the partition wall. The outflow side catalyst layer is disposed on a surface of the partition wall and a surface of the inflow side catalyst layer in an outflow side catalyst region. The surface of the partition wall is in a portion not overlapping with the inflow side catalyst region. The surface of the inflow side catalyst layer is in a portion overlapping with the inflow side catalyst region. The outflow side catalyst region extends from an outflow side end of the partition wall along the extending direction to an inflow side by a distance of 60% to 90% of the total length in the extending direction of the partition wall.

### CROSS REFERENCE TO RELATED APPLICATIONS

The present application claims priority from Japanese patent application JP 2023-077700 filed on May 10, 2023, the entire content of which is hereby incorporated by reference into this application.

### BACKGROUND

### Description of Related Art

The present disclosure relates to an electrically heated catalyst device used for purifying exhaust gas of internal combustion engines.

### Background Art

In recent years, an electrically heated catalyst device (hereinafter, sometimes abbreviated as “EHC”) has been attracting attention as an exhaust gas purification device for purifying exhaust gas of internal combustion engines of vehicles (automobiles) and the like. To allow the exhaust gas purification device to sufficiently exhibit the purification performance, the temperature of a catalyst used for the exhaust gas purification device need to increase to an activation temperature. Since the catalyst in a general exhaust gas purification device is heated by using the heat of the exhaust gas, when the temperature of the exhaust gas is low, such as immediately after the internal combustion engine starts operating, high purification performance cannot be obtained. Meanwhile, in the EHC, even when the temperature of the exhaust gas is low, such as immediately after the internal combustion engine starts operating, the temperature of the catalyst can be increased by electric heating to activate the catalyst. Therefore, even when the temperature of the exhaust gas is low, high purification performance can be obtained, and the purification efficiency of the exhaust gas can be enhanced.

A general configuration of the EHC includes a substrate and a catalyst layer. The substrate contains SiC functioning as a resistance heating element, and the catalyst layer contains a platinum group metal as a catalyst component. As a conventional EHC, for example, an EHC described in JP 2021-104484 A is known. This EHC includes a substrate, a catalyst layer, an intermediate layer arranged between the substrate and the catalyst layer, and electrodes. The substrate contains SiC. The catalyst layer contains a platinum group metal as a catalyst component. The intermediate layer substantially contains no platinum group metal. A product of the thickness [μm] of the intermediate layer and the specific surface area [m²/g] of the intermediate layer is 1100 or more. With this EHC, since the intermediate layer has an appropriate thickness and an appropriate specific surface area, the intermediate layer exhibits a high function as a physical barrier that obstructs migration of the platinum group metal. This allows suppressing the migration of the platinum group metal from the catalyst layer to the substrate and improving high temperature durability of the EHC.

### SUMMARY

Even in various configurations of the conventional EHC, such as the configuration including the intermediate layer arranged between the substrate and the catalyst layer described in JP 2021-104484 A, there has been a possibility that the exhaust gas purification performance is insufficient. Therefore, the EHC is required to further improve the exhaust gas purification performance.

The present disclosure has been made in view of such points, and provides an electrically heated catalyst device (EHC) that can improve an exhaust gas purification performance.

In order to solve the problems described above, the electrically heated catalyst device of the present disclosure comprises a substrate, an inflow side catalyst layer, and an outflow side catalyst layer. The substrate contains SiC. The inflow side catalyst layer contains Pd as a catalyst component. The outflow side catalyst layer contains Rh as a catalyst component. The substrate includes a partition wall defining a plurality of cells extending from an inflow side end surface to an outflow side end surface. The inflow side catalyst layer is disposed on a surface of the partition wall in an inflow side catalyst region. The inflow side catalyst region extends from an inflow side end of the partition wall along an extending direction to an outflow side by a distance of 60% to 90% of a total length in the extending direction of the partition wall. The outflow side catalyst layer is disposed on a surface of the partition wall and a surface of the inflow side catalyst layer in an outflow side catalyst region. The surface of the partition wall is in a portion not overlapping with the inflow side catalyst region. The surface of the inflow side catalyst layer is in a portion overlapping with the inflow side catalyst region. The outflow side catalyst region extends from an outflow side end of the partition wall along the extending direction to an inflow side by a distance of 60% to 90% of the total length in the extending direction of the partition wall.

### Effect

With the electrically heated catalyst device according to the present disclosure, the exhaust gas purification performance can be improved.

### BRIEF DESCRIPTION OF THE DRAWINGS

FIG. 1 is a cross-sectional view schematically illustrating a catalytic converter including an EHC according to a first embodiment;

FIG. 2 is a perspective view schematically illustrating the EHC according to the first embodiment;

FIG. 3 is a cross-sectional view schematically illustrating a main part of a cross-sectional surface parallel to an extending direction of a partition wall in the EHC according to the first embodiment;

FIG. 4 is a graph indicating a change in a 50% HC conversion temperature with respect to coat widths of an inflow side catalyst layer and an outflow side catalyst layer obtained from EHCs in Example 1 and Comparative Example; and

FIG. 5 is a graph indicating a change in a maximum oxygen storage amount with respect to the coat widths of the inflow side catalyst layer and the outflow side catalyst layer obtained from EHCs in Examples 1 to 3.

### DETAILED DESCRIPTION OF THE EMBODIMENTS

The following describes embodiments regarding an electrically heated catalyst device (hereinafter, sometimes abbreviated as “EHC”) of the present disclosure. In the following description, an “inflow side” and an “outflow side” respectively refer to a side into which an exhaust gas flows and a side from which the exhaust gas flows out in respective elements. An “upstream side” and a “downstream side” respectively refer to an upstream side and a downstream side in a direction in which the exhaust gas flows. An “extending direction” is an extending direction of a partition wall (direction in which the partition wall extends), and refers to a direction that is approximately the same as an axial direction of a substrate and an extending direction of a cell (direction in which the cell extends). A “thickness direction” refers to a thickness direction of the partition wall (direction perpendicular to a surface on a cell side of the partition wall). A “width direction” refers to a width direction of the partition wall (direction perpendicular to both the extending direction and the thickness direction of the partition wall).

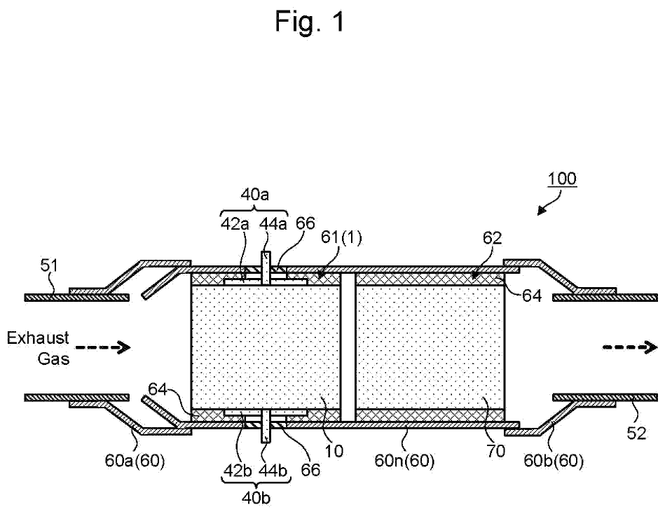

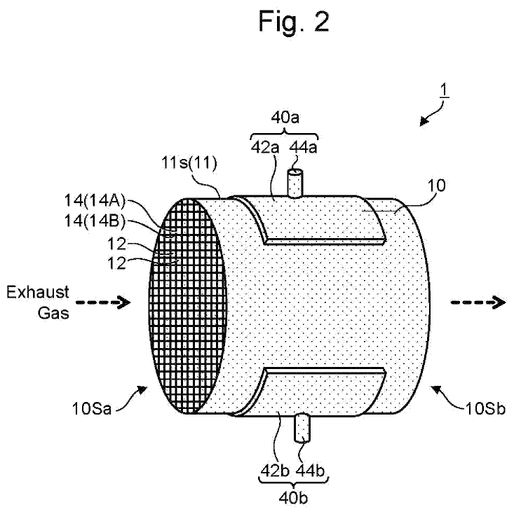

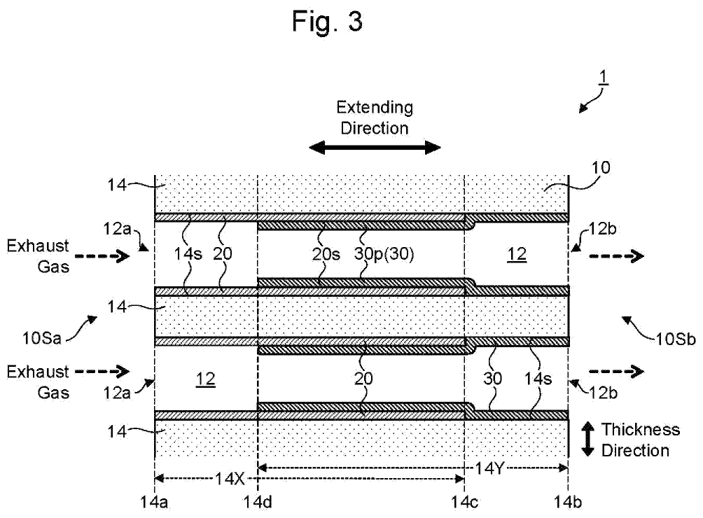

First, an outline of the EHC according to the embodiments will be described with an example of an EHC according to a first embodiment. FIG. 1 is a cross-sectional view schematically illustrating a catalytic converter including the EHC according to the first embodiment. FIG. 2 is a perspective view schematically illustrating the EHC according to the first embodiment. FIG. 3 is a cross-sectional view schematically illustrating a main part of a cross-sectional surface parallel to an extending direction of a partition wall in the EHC according to the first embodiment.

A catalytic converter 100 illustrated in FIG. 1 is installed in an exhaust passage (not illustrated) of an internal combustion engine (gasoline engine) mounted on a hybrid vehicle (automobile). The catalytic converter 100 is a tandem-type catalytic converter including a first exhaust gas purification device 61 as an EHC 1 according to the first embodiment and a second exhaust gas purification device 62. The catalytic converter 100 is further provided with a case 60 including an inner pipe 60n having a tubular shape, an inflow side connecting pipe 60a, and an outflow side connecting pipe 60b, mats 64, and an insulator 66. The inner pipe 60n, the inflow side connecting pipe 60a, and the outflow side connecting pipe 60b of the case 60 are made of, for example, a metal, such as stainless steel. The inflow side connecting pipe 60a is fixed to an inflow side of the inner pipe 60n covering the inflow side from the outer side, and decreases in diameter toward the inflow side. The outflow side connecting pipe 60b is fixed to a portion in an outflow side of the inner pipe 60n covering the outflow side from the outer side, and decreases in diameter toward the outflow side. The case 60 constitutes a part of the exhaust passage.

The first exhaust gas purification device 61 and the second exhaust gas purification device 62 are housed inside the inner pipe 60n of the case 60. The first exhaust gas purification device 61 is disposed on an upstream side with respect to the second exhaust gas purification device 62. Inside the inner pipe 60n of the case 60, the mats 64 are interposed between the first exhaust gas purification device 61 and an inner peripheral surface of the inner pipe 60n of the case 60, and between the second exhaust gas purification device 62 and the inner peripheral surface of the inner pipe 60n of the case 60. The mat 64 is an insulating body, and is formed of, for example, an inorganic fiber containing alumina as a main component. An insulation coat is provided on the inner peripheral surface of the inner pipe 60n of the case 60 by applying an insulating material. As the insulation coat, for example, a glass coat or the like is used.

The inflow side connecting pipe 60a of the case 60 connects an upstream side exhaust pipe 51 having a diameter smaller than a diameter of the inner pipe 60n of the case 60 to the inner pipe 60n. The inflow side of the inner pipe 60n of the case 60 decreases in diameter as it approaches the upstream side exhaust pipe 51, and a diameter of a portion closest to the upstream side exhaust pipe 51 is substantially equal to the diameter of the upstream side exhaust pipe 51. The outflow side connecting pipe 60b of the case 60 connects a downstream side exhaust pipe 52 having a diameter smaller than the diameter of the inner pipe 60n of the case 60 to the inner pipe 60n. The upstream side exhaust pipe 51 and the downstream side exhaust pipe 52 each constitute a part of the exhaust passage.

The first exhaust gas purification device 61 is a straight-flow type three-way catalyst, and is the EHC 1 according to the first embodiment. As illustrated in FIG. 1 to FIG. 3, the EHC 1 according to the first embodiment is a straight-flow type three-way catalyst including a substrate 10, an inflow side catalyst layer 20, an outflow side catalyst layer 30, and a positive electrode 40a and a negative electrode 40b.

The substrate 10 is a member supporting the inflow side catalyst layer 20 and the outflow side catalyst layer 30. The substrate 10 contains a Si—SiC composite material. The substrate 10 is a substrate in which a frame portion 11 and a partition wall 14 that partitions a space inside the frame portion 11 are integrally formed. The outer shape of the frame portion 11 is cylindrical. The partition wall 14 is a porous body that defines a plurality of cells 12. The plurality of cells 12 extend from an inflow side end surface 10Sa to an outflow side end surface 10Sb of the substrate 10. The shape of the partition wall 14 includes a plurality of wall portions 14A and a plurality of wall portions 14B such that a cross-sectional shape perpendicular to the extending direction of the plurality of cells 12 is rectangular, and a cross-section of the partition wall 14 perpendicular to the extending direction has a grid shape. The plurality of wall portions 14A are arranged in parallel being spaced apart from one another. The plurality of wall portions 14B are perpendicular to the plurality of wall portions 14A and arranged in parallel being spaced apart from one another. The plurality of cells 12 are adjacent to one another with the partition wall 14 interposed therebetween, and both of an inflow side end 12a and an outflow side end 12b in each of the cells 12 are open.

The inflow side catalyst layer 20 contains Pd (palladium) as a catalyst component, a carrier, and a Ba compound (such as BaSO₄). The carrier contains an OSC material as a composite oxide containing CeO₂ and ZrO₂ as a main component, and an oxide other than the OSC material. The catalyst component and the Ba compound are supported by the carrier containing the OSC material and the oxide other than the OSC material. The inflow side catalyst layer 20 is disposed on a surface 14s on the cell side of the partition wall 14 in an inflow side catalyst region 14X. The inflow side catalyst region 14X extends from an inflow side end 14a of the partition wall 14 along the extending direction to a position 14c that is separated from the inflow side end 14a along the extending direction to an outflow side by a distance of 60% to 90% of the total length in the extending direction of the partition wall 14.

The outflow side catalyst layer 30 contains Rh (rhodium) as a catalyst component and a carrier containing an OSC material and an oxide other than the OSC material. The catalyst component is supported by the carrier containing the OSC material and the oxide other than the OSC material. The outflow side catalyst layer 30 is disposed on the surface 14s on the cell side of the partition wall 14 and a surface 20s of the inflow side catalyst layer 20 in an outflow side catalyst region 14Y. The surface 14s of the partition wall 14 in the outflow side catalyst region 14Y is in a portion not overlapping with the inflow side catalyst region 14X. The surface 20s of the inflow side catalyst layer 20 in the outflow side catalyst region 14Y is in a portion overlapping with the inflow side catalyst region 14X. The outflow side catalyst region 14Y extends from an outflow side end 14b of the partition wall 14 along the extending direction to a position 14d that is separated from the outflow side end 14b along the extending direction to an inflow side by a distance of 60% to 90% of the total length in the extending direction of the partition wall 14. A part 30p on the inflow side of the outflow side catalyst layer 30 overlaps with the inflow side catalyst layer 20.

The positive electrode 40a and the negative electrode 40b are attached to an outer peripheral surface 11s of the frame portion 11 of the substrate 10. The positive electrode 40a includes a positive electrode layer 42a disposed on the outer peripheral surface 11s of the frame portion 11 and a positive electrode terminal 44a connected to the positive electrode layer 42a. The negative electrode 40b includes a negative electrode layer 42b disposed on the outer peripheral surface 11s of the frame portion 11 of the substrate 10 and a negative electrode terminal 44b connected to the negative electrode layer 42b. The positive electrode layer 42a and the negative electrode layer 42b extend in a circumferential direction and an axial direction along the outer peripheral surface 11s of the frame portion 11 such that a current can be caused to flow uniformly through the entire substrate 10. The positive electrode terminal 44a and the negative electrode terminal 44b each penetrate a wall of the inner pipe 60n of the case 60. The insulator 66 is fitted between the positive electrode terminal 44a and the wall of the inner pipe 60n of the case 60, and between the negative electrode terminal 44b and the wall of the inner pipe 60n of the case 60. The insulator 66 is made of, for example, an insulating material, such as alumina. This allows the EHC 1 to be electrically insulated from the case 60. In the EHC 1, a voltage is applied between the positive electrode 40a and the negative electrode 40b to cause a current to flow through the substrate 10, and thereby the substrate 10 is heated by electrical resistance.

As illustrated in FIG. 1, the second exhaust gas purification device 62 is a straight-flow type three-way catalyst including a substrate 70 and a catalyst layer (not illustrated). The substrate 70 is a member supporting the catalyst layer. The substrate 70 contains cordierite. The substrate 70 is a substrate in which a frame portion (not illustrated) and a partition wall (not illustrated) that partitions a space inside the frame portion are integrally formed. The outer shape of the frame portion is cylindrical. The partition wall is a porous body that defines a plurality of cells (not illustrated) extending from an inflow side end surface to an outflow side end surface of the substrate 70. The plurality of cells are adjacent to one another with the partition wall interposed therebetween, and both of an inflow side end and an outflow side end in each of the cells are open. The catalyst layer is disposed on a surface on the cell side of the partition wall. The catalyst layer contains Pd and Rh as catalyst components, a carrier containing an OSC material and an oxide other than the OSC material, and a Ba compound (such as BaSO₄). The catalyst components and the Ba compound are supported by the carrier containing the OSC material and the oxide other than the OSC material.

During operation of the internal combustion engine, when the exhaust gas passes through the catalytic converter 100, the exhaust gas first flows in from the inflow side end 12a to the plurality of cells 12 of the EHC 1 (first exhaust gas purification device 61) according to the first embodiment. The exhaust gas then flows out from the outflow side end 12b to the outside of the plurality of cells 12. Subsequently, the exhaust gas flows in from the inflow side end to the plurality of cells of the second exhaust gas purification device 62, and flows out from the outflow side end to the outside of the plurality of cells. In the catalytic converter 100, by applying a voltage between the positive electrode 40a and the negative electrode 40b of the EHC 1 to cause a current to flow through the substrate 10, the substrate 10 can be heated by electrical resistance before starting the operation of the internal combustion engine. This allows increasing the temperature of the catalyst of the EHC 1 to activate the catalyst even immediately after the internal combustion engine starts operating at which the temperature of the exhaust gas is low. Further, it is also possible to increase the temperature of the catalyst of the second exhaust gas purification device 62 and activate the catalyst by using the heat of the exhaust gas being heated by passing through the EHC 1.

In the EHC 1 according to the first embodiment, the part 30p on the inflow side of the outflow side catalyst layer 30 overlaps with the inflow side catalyst layer 20. Therefore, Si in the substrate 10 being diffused to the outflow side catalyst layer 30 is suppressed by a barrier action of the inflow side catalyst layer 20. The outflow side catalyst layer 30 contains Rh as a catalyst component that largely contributes to the purification performance. This allows suppressing deterioration of the outflow side catalyst layer 30 and improving the purification performance.

When proportions of the lengths of the inflow side catalyst layer 20 and the outflow side catalyst layer 30 in the extending direction with respect to the total length in the extending direction of the partition wall 14 (hereinafter, sometimes abbreviated as a “coat width of the inflow side catalyst layer 20” and a “coat width of the outflow side catalyst layer 30” respectively) are 60% or more, the proportion of a portion 30 (30p) overlapping with the inflow side catalyst layer 20 in the outflow side catalyst layer 30 increases. This allows the barrier action of the inflow side catalyst layer 20 to effectively suppress Si in the substrate 10 being diffused to the outflow side catalyst layer 30, and allows effectively suppressing deterioration of the outflow side catalyst layer. Further, when the coat widths of those catalyst layers are 60% or more, areas of contact of those catalyst layers with the exhaust gas increase. This allows the purification performance to be effectively improved.

When the coat widths of the inflow side catalyst layer 20 and the outflow side catalyst layer 30 are 60% or more, compared with when the total coat amount of those layers is the same and the coat widths of those layers are less than 60%, those layers become thinner allowing a pressure loss to be reduced. Note that, since the substrate 10 contains the Si—SiC composite material, for example, compared with a normal substrate containing cordierite, the partition wall becomes thicker and vent holes of the partition wall become narrower. This allows the reduction of the pressure loss to be large.

When the coat widths of the inflow side catalyst layer 20 and the outflow side catalyst layer 30 are 60% or more, the densities of those layers can be suppressed. Therefore, a temperature increase due to a reaction heat of a catalytic reaction in a region where these layers are disposed in the substrate 10 can be suppressed. Thus, generation of cracks in the substrate 10 can be suppressed.

When the coat widths of the inflow side catalyst layer 20 and the outflow side catalyst layer 30 are 90% or less, a decrease in the coat amounts of those layers can be suppressed, and the purification performance can be improved. Specifically, in a mass production process of the EHC 1, a slurry for the inflow side catalyst layer and a slurry for the outflow side catalyst layer are sometimes coated on the surface 14s of the partition wall 14. In that case, an error of about 10% of the total length in the extending direction of the partition wall 14 possibly occurs in the lengths in the extending direction of the regions where those slurries are actually coated. Meanwhile, a case where the coat widths of the inflow side catalyst layer 20 and the outflow side catalyst layer 30 are 90% or less is assumed. In this case, even when such error occurs when those slurries are coated on the surface 14s of the partition wall 14 in the mass production process, it is possible to suppress those slurries from leaking out from each of the outflow side end 12b and the inflow side end 12a to the outside of the cells 12. This allows decreasing the coat amounts of those layers and improving the purification performance.

Therefore, with the EHC according to the embodiment, for example, similarly to the EHC 1 according to the first embodiment, the exhaust gas purification performance can be improved. In addition, the pressure loss can be reduced, and the generation of cracks in the substrate can be suppressed. Next, the respective configurations of the EHC according to the embodiment will be described in detail.

### 1. Substrate

The substrate contains SiC (silicon carbide), and includes a partition wall that defines a plurality of cells extending from an inflow side end surface to an outflow side end surface.

Since the substrate contains SiC, generation of cracks caused by a thermal cycle becomes less likely to occur, and the substrate can function as a resistance heating element. Therefore, since the substrate contains SiC, the EHC according to the embodiment can be used as the electrically heated catalyst device. The substrate may be, for example, a substrate containing SiC as a pure substance, or a substrate containing Si—SiC (silicon-silicon carbide) composite material in which Si is bonded to SiC. In some embodiments, the substrate contains the Si—SiC composite material because it allows obtaining excellent conductivity.

The substrate is usually a substrate in which a frame portion and a partition wall that partitions a space inside the frame portion are integrally formed. The outer shape (outer shape of the frame portion) of the substrate is not particularly limited, and may be, for example, cylindrical or the like. When the outer shape of the substrate is cylindrical, the outer diameter of the substrate (outer diameter of the frame portion) is not particularly limited and may be similar to that of a known EHC. For example, the outer diameter is 75 mm or more and 95 mm or less in some embodiments. The reason is because, when the outer diameter is equal to or greater than the lower limit, an increase in the pressure loss can be avoided. The reason is also because, when the outer diameter is equal to or smaller than the upper limit, a difference in a temperature distribution in the radial direction during electric heating can be suppressed. The length in the axial direction of the substrate is not particularly limited, and may be similar to that of a known EHC. For example, when the EHC is used in a tandem-type catalytic converter as in the first embodiment, the length in the axial direction of the substrate is 45 mm or more and 70 mm or less in some embodiments. The reason is because, when the length is equal to or greater than the lower limit, the purification property can be ensured. The reason is also because, when the length is equal to or less than the upper limit, the pressure loss can be reduced.

The shape of the partition wall is not particularly limited, and may be similar to that of a known EHC. The shape of the partition wall usually includes a plurality of 1st wall portions arranged in parallel being spaced apart from one another and a plurality of 2nd wall portions intersecting with the plurality of 1st wall portions and arranged in parallel being spaced apart from one another such that a cross-sectional shape perpendicular to the extending direction of the plurality of cells has a desired shape. While the length in the extending direction of the partition wall is not particularly limited, it is usually substantially the same as the length in the axial direction of the substrate. The thickness of the partition wall is not particularly limited, and may be similar to that of a known EHC. For example, the thickness is 85 μm or more and 210 μm or less in some embodiments. The reason is because, when the thickness is equal to or greater than the lower limit, the reduction of the pressure loss due to the inflow side catalyst layer and the outflow side catalyst layer having a coat width of 60% or more becomes remarkably effective, and structural reliability can be ensured. The reason is also because, when the thickness is equal to or less than the upper limit, unnecessary increase in the pressure loss can be avoided.

The partition wall is a porous body. The porosity of the partition wall is not particularly limited, and may be similar to that of a known EHC. For example, the porosity is 35% or more and 45% or less in some embodiments. The reason is because, when the porosity is equal to or greater than the lower limit, an unnecessary increase in the pressure loss can be avoided. The reason is also because, when the porosity is equal to or lower than the upper limit, the reduction of the pressure loss due to the inflow side catalyst layer and the outflow side catalyst layer having a coat width of 60% or more becomes remarkably effective. An average pore size of the pores in the partition wall is not particularly limited, and may be similar to that of a known EHC. For example, the average pore size is 4 μm or more and 11 μm or less in some embodiments. The reason is because, when the average pore size is equal to or greater than the lower limit, an unnecessary increase in the pressure loss can be avoided. The reason is also because, when the average pore size is equal to or smaller than the upper limit, the reduction of the pressure loss due to the inflow side catalyst layer and the outflow side catalyst layer having a coat width of 60% or more becomes remarkably effective. Note that the “average pore size of the pores in the partition wall” refers to, for example, those measured by a mercury penetration method.

The cross-sectional shape perpendicular to the extending direction of the plurality of cells is not particularly limited, and may be similar to that of a known EHC. For example, the cross-sectional shape may be a polygon, such as a rectangle, a circular shape, or the like. The cell density is not particularly limited, and may be similar to that of a known EHC. For example, the cell density is 350 or more and 700 or less per square inch in some embodiments. The reason is because, when the cell density is equal to or greater than the lower limit, contactability thereof with the exhaust gas increases, and the purification property can be ensured. The reason is also because, when the cell density is equal to or lower than the upper limit, an increase in the pressure loss can be avoided. While the length in the extending direction of the plurality of cells is not particularly limited, it is usually substantially the same as the length in the axial direction of the substrate.

### 2. Inflow Side Catalyst Layer

The inflow side catalyst layer contains Pd as a catalyst component. Pd has excellent exhaust gas purification performance for CO and HC. The inflow side catalyst layer is disposed on a surface of the partition wall in the inflow side catalyst region. The inflow side catalyst region extends from the inflow side end of the partition wall along the extending direction to the outflow side by a distance of 60% to 90% of the total length in the extending direction of the partition wall.

Pd is in the form of fine particles from the viewpoint of increasing an area of contact with the exhaust gas in some embodiments. The average particle diameter of Pd in the form of fine particles is, for example, 1 nm or more and 15 nm or less in some embodiments. By obtaining an electron microscope image (such as a TEM image) of Pd, the average particle diameter of Pd can be determined as the mean value of the particle diameters of any 20 or more particles in the image.

The inflow side catalyst layer usually contains an OSC material (oxygen storage capacity material). The OSC material is not particularly limited as long as it has an oxygen storage capacity, and examples thereof include CeO₂ and a composite oxide containing CeO₂. Examples of the composite oxide containing CeO₂ include a ceria-zirconia-based composite oxide containing CeO₂ and ZrO₂. An example of the OSC material is particularly the ceria-zirconia-based composite oxide in some embodiments. The reason is because ZrO₂ can suppress heat deterioration of CeO₂. An example of the ceria-zirconia-based composite oxide may be a ceria-zirconia composite oxide made of CeO₂ and ZrO₂, or may be one that contains a metallic element other than Ce or Zr. Examples of the metallic element other than Ce or Zr include rare earth elements (such as Sc, Y, La, Pr, Nd, Pm, Sm, Eu, Gd, Tb, Dy, Ho, Er, Tm, Yb, and Lu) in some embodiments. The reason is because heat resistance, oxygen absorption and release properties, and the like can be improved. The content of CeO₂ in the composite oxide containing CeO₂ is, for example, 15 mass % or more and 55 mass % or less in some embodiments. The reason is because, when the content is equal to or greater than the lower limit, the composite oxide can sufficiently exhibit the oxygen storage capacity. The reason is also because, when the content is equal to or less than the upper limit, the basicity of the OSC material can be suppressed.

The OSC material may be one that functions as a carrier supporting Pd. The inflow side catalyst layer may further contain a carrier other than the OSC material as a carrier supporting Pd. Examples of the carrier other than the OSC material include a carrier containing an oxide other than the OSC material. Examples of the oxide include Al₂O₃, TiO₂, ZrO₂, SiO₂, and an alumina-zirconia-based composite oxide containing Al₂O₃ and ZrO₂. The carrier containing an oxide other than the OSC material may be one that further contains an oxide of a rare earth element. The reason is because heat resistance and the like can be improved. Examples of the oxide of a rare earth element include Pr₂O₃, Nd₂O₃, La₂O₃, and Y₂O₃. The content of the oxide of a rare earth element in the carrier containing the oxide other than the OSC material may be, for example, 1 mass % or more and 10 mass % or less.

The content of Pd in the inflow side catalyst layer is not particularly limited. For example, in some embodiments, the content is 0.01 mass % or more and 8 mass % or less with respect to the total mass of the OSC material and the carrier other than the OSC material contained in the inflow side catalyst layer.

The inflow side catalyst layer may be one that further contains at least one type of Ba component selected from the group consisting of Ba (barium) and Ba compounds. The reason is because the Ba component can suppress Pd being poisoned by HC, and suppress sintering of Pd. Examples of the Ba compound include BaSO₄, (CH₃COO)₂Ba, Ba(NO₃)₂, and BaCO₃. Among them, the Ba compound is BaSO₄, (CH₃COO)₂Ba, or the like in some embodiments, and is particularly BaSO₄ in some embodiments.

Generally, in order for the Ba component to be highly diffused in the inflow side catalyst layer, the average grain diameter of the Ba component should be as small as possible. Especially, when the average grain diameter is several nm, diffusivity of the Ba component becomes remarkably excellent. However, the average grain diameter of the Ba component is 100 nm or more and 350 nm or less. By significantly increasing the average grain diameter of the Ba component from several nm, it is possible to reduce contact between Ba elements contained in the inflow side catalyst layer and Si contained in the substrate. Further, by the average grain diameter of the Ba component being set to 100 nm or more and 350 nm or less, the Ba elements together with Pd can be dispersed and be present in the inflow side catalyst layer. Therefore, by the average grain diameter of the Ba component being set to 100 nm or more and 350 nm or less, it is possible to suppress Si in the substrate being diffused to the inflow side catalyst layer by the Ba elements. This allows suppressing deterioration of the OSC material, and therefore improving the high temperature durability of the OSC material. The average grain diameter of the Ba component is particularly 150 nm or more and 200 nm or less in some embodiments. The reason is because the high temperature durability of the OSC material can be remarkably improved. By setting the average grain diameter of the Ba component to 100 nm or more, it is possible to suppress breakage of the substrate and improve a conversion performance of NOx.

The average grain diameter of the Ba component can be obtained by, for example, the following method. First, a part of the inflow side catalyst layer is taken as a sample from the EHC. Next, an image of the sample is photographed, for example, by using an electron microscope, such as an SEM or TEM. Next, 20 or more grains that are entirely visible among the grains (particles) of the Ba component in the photographed image are selected, and the areas of the selected respective grains are measured. Next, diameters of circles having areas equal to the areas of the selected respective grains are calculated. Next, the arithmetic mean of the calculated diameters for the selected respective grains is calculated as the average grain diameter of the Ba component.

The Ba component is present at least on a surface of the OSC material, and is usually supported by the OSC material. The Ba component may be supported by both the OSC material and the carrier other than the OSC material. The proportion of the Ba component supported by the OSC material in the Ba component is, for example, 10 mass % or more. The dispersion form of the Ba component is not particularly limited. Usually, the inflow side catalyst layer is formed by a slurry in which a source of the catalyst component, a source of the Ba component, the OSC material, and the like are mixed and coated on the surface of the partition wall. Therefore, the Ba component is uniformly dispersed inside the inflow side catalyst layer. The content of the Ba component in the inflow side catalyst layer is not particularly limited. For example, a ratio of the mass of the Ba component converted into sulfate to the mass of Pd contained in the inflow side catalyst layer is 1/80 or more and 1/20 or less.

The inflow side catalyst layer may further contain, for example, a binder, an additive, and the like, in addition to Pd, the Ba component, the OSC material, the carrier other than the OSC material, and the like. Examples of the binder include alumina sol and silica sol. Examples of the additive include a NOx adsorber and a stabilizer.

The thickness of the inflow side catalyst layer is not particularly limited, and may be appropriately determined in accordance with the cell size of the substrate, the flow rate of the exhaust gas supplied to the EHC, and the like. The thickness of the inflow side catalyst layer is not particularly limited, and is, for example, 1 μm or more and 500 μm or less in some embodiments. The coat amount of the inflow side catalyst layer is not particularly limited, and is, for example, 50 g/L or more and 150 g/L or less, in some embodiments. The reason is because, when the coat amount is equal to or greater than the lower limit, the purification performance can be effectively improved. The reason is also because, when the coat amount is equal to or less than the upper limit, the pressure loss can be effectively suppressed. Note that the “coat amount of the inflow side catalyst layer” refers to a value obtained by the mass of the inflow side catalyst layer being divided by the volume of the substrate.

### 3. Outflow Side Catalyst Layer

The outflow side catalyst layer contains Rh as a catalyst component. Rh has an excellent conversion performance of NOx. The outflow side catalyst layer is disposed in a surface of the partition wall and a surface of the inflow side catalyst layer in the outflow side catalyst region. The surface of the partition wall is in a portion not overlapping with the inflow side catalyst region. The surface of the inflow side catalyst layer is in a portion overlapping with the inflow side catalyst region. The outflow side catalyst region extends from the outflow side end of the partition wall along the extending direction to the inflow side by a distance of 60% to 90% of the total length in the extending direction of the partition wall.

Rh is in the form of fine particles from the viewpoint of increasing an area of contact with the exhaust gas in some embodiments. The average particle diameter of Rh in the form of fine particles is, for example, 1 nm or more and 15 nm or less in some embodiments. By obtaining an electron microscope image (such as a TEM image) of Rh, the average particle diameter of Rh can be determined as the mean value of the particle diameters of any 20 or more particles in the image.

The outflow side catalyst layer usually contains an OSC material. The OSC material is similar to the OSC material described in the above section “2. Inflow Side Catalyst Layer.” The OSC material may be one that functions as a carrier supporting Rh. The outflow side catalyst layer may further contain a carrier other than the OSC material as a carrier supporting Rh. The carrier other than the OSC material is similar to the carrier other than the OSC material described in the above section “2. Inflow Side Catalyst Layer.”

The content of Rh in the outflow side catalyst layer is not particularly limited. For example, the content is 0.01 mass % or more and 8 mass % or less with respect to the total mass of the OSC material and the carrier other than the OSC material contained in the outflow side catalyst layer in some embodiments.

The outflow side catalyst layer may further contain, for example, a binder, an additive, and the like, in addition to Rh, the OSC material, the carrier other than the OSC material, and the like. The binder and the additive are similar to the binder and the additive described in the above section “2. Inflow Side Catalyst Layer.”

The thickness of the outflow side catalyst layer is not particularly limited, and may be appropriately determined in accordance with the cell size of the substrate, the flow rate of the exhaust gas supplied to the EHC, and the like. The thickness of the outflow side catalyst layer is not particularly limited, and is, for example, 1 μm or more and 500 μm or less in some embodiments. The coat amount of the outflow side catalyst layer is not particularly limited, and is, for example, 30 g/L or more and 100 g/L or less in some embodiments. The reason is because, when the coat amount is equal to or greater than the lower limit, the purification performance can be effectively improved. The reason is also because, when the coat amount is equal to or less than the upper limit, the pressure loss can be effectively suppressed. Note that the “coat amount of the outflow side catalyst layer” refers to a value obtained by the mass of the outflow side catalyst layer being divided by the volume of the substrate.

### 4. EHC

The EHC according to the embodiment includes the substrate, the inflow side catalyst layer, and the outflow side catalyst layer. The EHC may further include a positive electrode and a negative electrode, as in the first embodiment. The positive electrode and the negative electrode are not particularly limited, and may be similar to those in a known EHC. Examples of the positive electrode and the negative electrode include a metal electrode and a carbon electrode. The type of EHC is not particularly limited, and may be a straight-flow type or a wall-flow type three-way catalyst. The EHC is disposed in an exhaust passage of an internal combustion engine of an vehicle (automobile) and the like, and is used for purifying exhaust gas of the internal combustion engine. The EHC is not particularly limited, and is, for example, as in the first embodiment, one used in a tandem-type catalytic converter in some embodiments.

### EXAMPLES

The EHC according to the embodiment will be described in more detail below with reference to Examples and Comparative Example.

### Example 1

An example of an EHC (straight-flow type three-way catalyst) similar to the EHC according to the first embodiment except for the point that the positive electrode and the negative electrode were not provided was manufactured. First, a substrate in which a frame portion having a cylindrical shape and a partition wall were integrally formed was prepared. The configuration of the substrate is as follows.

### (Substrate)

Substrate material: Si—SiC composite material
Substrate size: outer diameter×length in axial direction=80 mm×65 mm
Partition wall thickness: 190 μm
Partition wall porosity: 40%
Average pore size of partition wall pores: 7.5 μm
Cell density: 600 per square inch

Next, a palladium nitrate solution, a ceria-zirconia-based composite oxide powder, an Al₂O₃ powder, BaSO₄ having an average grain diameter of 100 nm, a binder, and an ion-exchanged water were mixed. Thus, a slurry for the inflow side catalyst layer (Pd-containing slurry) was prepared.

Next, the slurry for the inflow side catalyst layer was poured into the cells of the substrate from the inflow side end. Thus, the slurry was coated on and supplied to a surface on the cell side of the partition wall in the inflow side catalyst region. The inflow side catalyst region extended from the inflow side end of the partition wall along the extending direction to the outflow side by a distance of 90% of the total length in the extending direction of the partition wall. At this time, the supply amount of the slurry was adjusted such that the coat amount of the inflow side catalyst layer (value obtained by the mass of the inflow side catalyst layer being divided by the volume of the substrate) was 88.5 g/L. Next, the substrate on which the slurry was coated was heated at 120° C. in a dryer for 2 hours to be dried, and then fired at 500° C. in an electric furnace for 2 hours. Thus, the inflow side catalyst layer was formed such that the proportion of the length in the extending direction of the inflow side catalyst layer with respect to the total length in the extending direction of the partition wall (hereinafter, abbreviated as the “coat width of the inflow side catalyst layer”) was 90%.

Next, a rhodium nitrate solution, a ceria-zirconia-based composite oxide powder, an alumina-zirconia-based composite oxide powder, an Al₂O₃ powder, a binder, and an ion-exchanged water were mixed. Thus, a slurry for the outflow side catalyst layer (Rh-containing slurry) was prepared.

Next, the slurry for the outflow side catalyst layer was poured into the cells of the substrate from the outflow side end. Thus, the slurry for the outflow side catalyst layer was coated on and supplied to a surface on the cell side of the partition wall and a surface of the inflow side catalyst layer in the outflow side catalyst region. The surface on the cell side of the partition wall was in a portion not overlapping with the inflow side catalyst region. The surface of the inflow side catalyst layer was in a portion overlapping with the inflow side catalyst region. The outflow side catalyst region extended from the outflow side end of the partition wall along the extending direction to the inflow side by a distance of 90% of the total length in the extending direction of the partition wall. At this time, the supply amount of the slurry was adjusted such that the coat amount of the outflow side catalyst layer (value obtained by the mass of the outflow side catalyst layer being divided by the volume of the substrate) was 49.5 g/L. Next, the substrate on which the slurry was coated was heated at 120° C. in the dryer for 2 hours to be dried, and then fired at 500° C. in the electric furnace for 2 hours. Thus, the outflow side catalyst layer was formed such that the proportion of the length in the extending direction of the outflow side catalyst layer with respect to the total length in the extending direction of the partition wall (hereinafter, abbreviated as the “coat width of the outflow side catalyst layer”) was 90%. Based on the above, the EHC was manufactured.

### Example 2

An EHC was manufactured in a method similar to Example 1 except for the following points. A region extending from the inflow side end of the partition wall along the extending direction to the outflow side by a distance of 75% of the total length in the extending direction of the partition wall was defined as the inflow side catalyst region, thus, the inflow side catalyst layer had a coat width of 75%. Further, a region extending from the outflow side end of the partition wall along the extending direction to the inflow side by a distance of 75% of the total length in the extending direction of the partition wall was defined as the outflow side catalyst region, thus the outflow side catalyst layer had a coat width of 75%.

### Example 3

An EHC was manufactured in a method similar to Example 1 except for the following points. A region extending from the inflow side end of the partition wall along the extending direction to the outflow side by a distance of 60% of the total length in the extending direction of the partition wall was defined as the inflow side catalyst region, thus the inflow side catalyst layer had a coat width of 60%. Further, a region extending from the outflow side end of the partition wall along the extending direction to the inflow side by a distance of 60% of the total length in the extending direction of the partition wall was defined as the outflow side catalyst region, thus the outflow side catalyst layer had a coat width of 60%.

### COMPARATIVE EXAMPLE

An EHC was manufactured in a method similar to Example 1 except for the following points. A region extending from the inflow side end of the partition wall along the extending direction to the outflow side by a distance of 55% of the total length in the extending direction of the partition wall was defined as the inflow side catalyst region, thus the inflow side catalyst layer had a coat width of 55%. Further, a region extending from the outflow side end of the partition wall along the extending direction to the inflow side by a distance of 55% of the total length in the extending direction of the partition wall was defined as the outflow side catalyst region, thus the outflow side catalyst layer had a coat width of 55%.

### [Evaluation]

For the EHCs manufactured in Examples 1 to 3 and Comparative Example, the exhaust gas purification performance and the oxygen storage capacity with respect to the coat widths of the inflow side catalyst layer and the outflow side catalyst layer were evaluated.

### (Exhaust Gas Purification Performance)

For the EHCs in Example 1 and Comparative Example, as an index of the exhaust gas purification performance, a temperature (50% HC conversion temperature) at which an HC component of the exhaust gas can be converted by 50% was measured. At this time, the EHCs in the respective Examples were first installed in an exhaust passage of an engine bench, and a combustion condition of the engine was controlled by a stoichiometric air-fuel ratio. By using a heat exchanger, the temperature of gas flowing into the catalyst device was increased from 200° C. to 600° C. at a temperature increase rate of 20° C. per minute. An amount of intake air of the engine was set to 35 g/second. Gas components of the gas flowing into the catalyst and gas flowing out from the catalyst during the temperature increase were analyzed to measure the 50% HC conversion temperature. The results are shown in Table 1 below.

### (Oxygen Storage Capacity)

For the EHCs in Examples 1 to 3, the maximum oxygen storage amount was determined as an index of the oxygen storage capacity. At this time, first, as a durability test of the EHCs in the respective Examples, an 80-hour deterioration accelerating test at a catalyst bed temperature of 950° C. was performed using a 1UR-FE engine manufactured by Toyota Motor Corporation. In the test, the deterioration was accelerated by adjusting a throttle opening and an engine load for an exhaust gas composition and repeating rich-stoichiometric-lean in a constant cycle. Subsequently, the EHC after the durability test was mounted on a 2AR-FE engine manufactured by Toyota Motor Corporation, and an inlet gas temperature was set at 600° C. With Air-Fuel ratio (A/F) of an inlet gas atmosphere being set to 14.1 and 15.1 as the target, a feedback control was performed while the A/F was oscillated cyclically. Based on the difference between a stoichiometric point and an output of an A/F sensor, an excess or shortage of oxygen was calculated by the equation: maximum oxygen storage amount (g)=0.23×ΔA/F× injection fuel amount, and the maximum oxygen storage amount was determined. The results are shown in Table 1 below.

TABLE 1

| | | | | Maximum |
|---|---|---|---|---|
| | Coat Width of | Coat Width of | 50% HC | Oxygen |
| | Inflow Side | Outflow Side | Conversion | Storage |
| | Catalyst | Catalyst | Temperature | Amount |
| | Layer [%] | Layer [%] | [° C.] | [g] |
| Example 1 | 90 | 90 | 380.6 | 0.15 |
| Example 2 | 75 | 75 | — | 0.13 |
| Example 3 | 60 | 60 | — | 0.11 |
| Comparative | 55 | 55 | 389.7 | — |
| Example 1 | | | | |

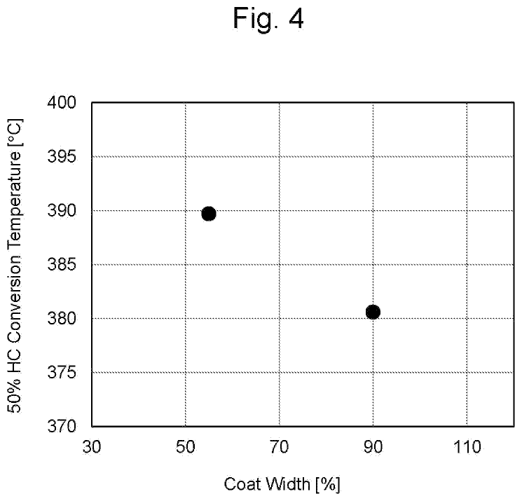

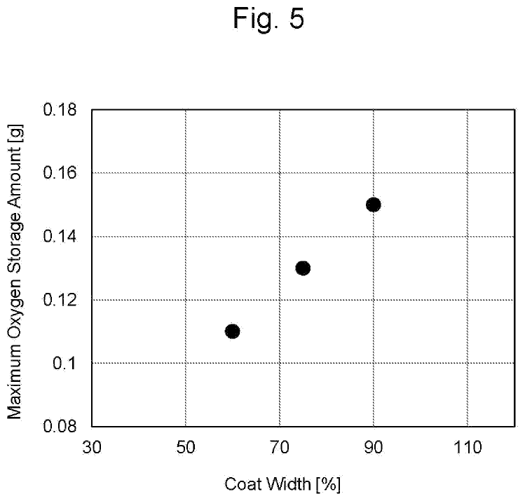

FIG. 4 is a graph indicating a change in the 50% HC conversion temperature with respect to the coat widths of the inflow side catalyst layer and the outflow side catalyst layer obtained from the EHCs in Example 1 and Comparative Example. FIG. 5 is a graph indicating a change in the maximum oxygen storage amount with respect to the coat widths of the inflow side catalyst layer and the outflow side catalyst layer obtained from the EHCs in Examples 1 to 3.

As indicated in Table 1 and FIG. 4, in the EHCs, as the coat widths of the inflow side catalyst layer and the outflow side catalyst layer increased from 55% to 90%, the 50% HC conversion temperature decreased. In addition, as illustrated in Table 1 and FIG. 5, in the EHCs, as the coat widths of the inflow side catalyst layer and the outflow side catalyst layer increased from 60% to 90%, the maximum oxygen storage amount increased. These results can be understood as follows. As these coat widths increased, the proportion of the portion overlapping with the inflow side catalyst layer in the outflow side catalyst layer increased. This allowed the barrier action of the inflow side catalyst layer to effectively suppress Si in the substrate being diffused to the outflow side catalyst layer containing Rh. These results can also be understood as follows. As these coat widths increased, the areas of contact of those catalyst layers with the exhaust gas increased.

The embodiments of the electrically heated catalyst device (EHC) of the present disclosure have been described in detail above. However, the present disclosure is not limited to the embodiments described above, and various kinds of changes of design are allowed within a range not departing from the spirits of the present disclosure described in the claims.

All publications, patents and patent applications cited in the present description are herein incorporated by reference as they are.

### DESCRIPTION OF SYMBOLS

1 Electrically heated catalyst device (EHC)
10 Substrate
10Sa Inflow side end surface
10Sb Outflow side end surface
11 Frame portion
12 Cell
12a Inflow side end
12b Outflow side end
14 Partition wall
14a Inflow side end
14b Outflow side end
14X Inflow side catalyst region
14Y Outflow side catalyst region
20 Inflow side catalyst layer
30 Outflow side catalyst layer

What is claimed is:

1. An electrically heated catalyst device comprising:
a substrate;
an inflow side catalyst layer; and
an outflow side catalyst layer,
wherein the substrate contains SiC,
wherein the inflow side catalyst layer contains Pd as a catalyst component,
wherein the outflow side catalyst layer contains Rh as a catalyst component,
wherein the substrate includes a partition wall defining a plurality of cells extending from an inflow side end surface to an outflow side end surface,
wherein the inflow side catalyst layer is disposed on a surface of the partition wall in an inflow side catalyst region, and the inflow side catalyst region extends from an inflow side end of the partition wall along an extending direction to an outflow side by a distance of 60% to 90% of a total length in the extending direction of the partition wall, and
wherein the outflow side catalyst layer is disposed on a surface of the partition wall and a surface of the inflow side catalyst layer in an outflow side catalyst region, the surface of the partition wall is in a portion not overlapping with the inflow side catalyst region, the surface of the inflow side catalyst layer is in a portion overlapping with the inflow side catalyst region, and the outflow side catalyst region extends from an outflow side end of the partition wall along the extending direction to an inflow side by a distance of 60% to 90% of the total length in the extending direction of the partition wall.
